(19) United States
(12) Patent Application Publication
(10) Pub. No.: US 2009/0129762 A1
(43) Pub. Date: May 21, 2009

(54) Initial Wetting Auxiliary Material for a Vaporiser Body

(76) Inventors: Ulrich Goetz, Halblech (DE); Michael Nurnberger, Altenstadt (DE)

Correspondence Address: FAY KAPLUN & MARCIN, LLP, 150 BROADWAY, SUITE 702, NEW YORK, NY, 10038, US

(21) Appl. No.: 11/994,180

(22) PCT Filed: Jun. 30, 2006
(86) PCT No.: PCT/DE2006/001123

§ 371 Date: Jul. 23, 2008

(30) Foreign Application Priority Data
Jul. 1, 2005 (DE) 10 2005 030 862.7

(51) Int. Cl. B01D 7/00; C09D 7/00; B05D 5/00

(52) U.S. Cl. 392/387; 106/311; 392/388; 427/126.1

(57) ABSTRACT

An initial wetting auxiliary material is for applying to a vaporiser surface of an electrically heatable ceramic vaporiser body. The vaporiser body is used for operation in a physical vapour deposition (PVD) metallisation installation for vaporising aluminium. The vaporiser body contains nitrogen as a material component. The auxiliary material comprises a powder mixture which comprises (a) aluminium in powder form having a particle size which is at most 0.6 mm. The aluminium in powder form melts on the vaporiser surface after initiating the operation of the vaporiser body and reacted with the nitrogen of the vaporiser body to form an aluminium nitride layer on the vaporiser surface. The powder mixture further comprises (b) a wetting agent in powder form promoting an even and large-surface distribution of the molten aluminium on the vaporiser surface.

The invention relates to an initial wetting auxiliary material to be applied to a vaporiser surface of an electrically heatable ceramic vaporiser body which is provided for operation in a PVD-metallisation installation for vaporising aluminium. The invention further relates to an electrically heatable ceramic vaporiser body having an initial wetting auxiliary material in accordance with the present invention applied to the vaporizer surface thereof. The invention further relates to a method for preparing an electrically heatable ceramic vaporiser body, wherein an initial wetting auxiliary material in accordance with the present invention is applied to the vaporiser surface of the vaporiser body prior to the heating of the same.

A common method for coating flexible substrates with metals, preferably aluminium, is the so-called vacuum band metallisation according to the PVD (physical vapour deposition) technology. Suitable flexible substrates are e.g. paper, plastic foils and textiles, and aluminium is mostly used as the metal. Such coated substrates are widely used for wrapping and decoration purposes, for the production of capacitors and in environmental technology (insulation).

The coating of the flexible substrates takes place in so-called metallisation installations. In the metallisation installation, the substrate to be coated is directed over a cooled roll and meanwhile exposed to a metal vapour which condensates on the surface of the substrate as a thin metal layer. For generating the required constant vapour flow, electrically heatable vaporiser bodies are used, preferably in the form of so-called vaporiser boats, which are heated to approximately 1450-1600° C. Metal wire is continuously supplied, liquefied on the surface of the vaporiser boat and vaporised under vacuum at approximately 10⁻⁴ mbar. The metal mainly used is aluminium.

Non-flexible substrates according to PVD-technology are coated batchwise in a discontinuous process, preferably by means of flash vaporisation. Non-flexible substrates are e.g. television screens and plastic parts.

The vaporiser bodies used in the continuous method and the discontinuous method normally consist of a hot-pressed ceramic material, the main components of which are titanium diboride and boron nitride. Titanium diboride is the electrically conductive component and boron nitride is the electrically insulating component, which, when mixed together, result in certain specific resistances.

In practice, the wetting of the metal to be vaporised on the vaporiser body at the beginning of the metallisation process is incomplete. As a result, merely decreased vaporisation rates (kilogram metal/time unit) can be realised at the beginning of the metallisation process due to the smaller wetting surface.

The invention provides an initial wetting auxiliary material, a vaporiser body having the initial wetting auxiliary material according to the invention and a method of the initially mentioned type, whereby an improved initial wetting of the vaporiser body by the aluminium to be vaporised is obtained, to thereby achieve increased vaporisation rates from the beginning of the vaporiser operation.

The invention provides an initial wetting auxiliary material to be applied to the vaporiser surface of an electrically heatable ceramic vaporiser body which is provided for operation in a PVD metallisation installation for the purpose of vaporising aluminium and which contains nitrogen, preferably in the form of boron nitride, as a material component. The initial wetting auxiliary material according to the present invention is a piece material or layer material, said layer material having at least one layer which may also be formed as a plate or foil material, and/or or a powder material, said initial wetting auxiliary material comprising at least two components: aluminium as a first component in such a condition that it melts on the vaporiser surface of the vaporiser body once operation of the same has been initiated and reacts with the nitrogen of the vaporiser body, thereby generating an aluminium nitride layer on the vaporiser surface, and a wetting agent (wetting medium) as a second component, by means of which an even and large-surface distribution of the molten aluminium is promoted on the vaporiser surface.

The vaporiser body is resistance-heated directly, i.e. in a direct current passage.

The aluminium of the initial wetting auxiliary material liquefied after initiation of the vaporiser is distributed rapidly and extensively on the vaporiser surface of the vaporiser body by means of the wetting agent, such that the vaporiser surface is almost entirely wetted by aluminium already at the beginning of the heating process. The wetting agent preferably causes a reduction of the wetting angle of the melting aluminium. The aluminium which is well distributed in this way then reacts with the boron nitride of the vaporiser body to form aluminium nitride. The aluminium nitride thus formed on the vaporiser surface is far better wetted by the aluminium than the boron nitride of the vaporiser body. If the vaporiser body is operated in an appropriate manner, the active wetting surface (= aluminium nitride layer generated on the vaporiser surface of the vaporiser body) formed by the initial wetting auxiliary material is maintained over the entire life of the vaporiser body.

By means of the aluminium nitride layer which can be provided very rapidly on the vaporiser surface of the vaporiser body at the initiation (= heating-up process) of the vaporiser body by means of the initial wetting auxiliary material, on which aluminium nitride layer the aluminium material to be vaporised is applied continuously, a considerable improvement of the wetting/coating of the vaporiser surface is achieved, since the aluminium nitride layer, in comparison to e.g. boron nitride, causes a strong reduction of the wetting angle of the aluminium (reduction of the surface tension) with regard to the vaporiser surface of the vaporiser body, so that the aluminium nitride layer and hence the vaporiser surface are wetted more rapidly. The aluminium of the initial wetting auxiliary material melts at the initiation of the operation of the vaporiser body, i.e. e.g. when an electrical current is directed through the same in order to electrically heat the same to an exemplary working temperature of 1450-1600° C. due to its ohmic resistance, wherein the wetting agent of the initial wetting auxiliary material causes a rapid and even distribution of the aluminium of the initial wetting auxiliary material on the vaporiser surface, wherein the corresponding surface on the vaporiser body, wetted by means of the molten aluminium of the initial wetting auxiliary material, represents the initial wetting surface. In this way an in-situ reaction of the aluminium with the nitrogen in the vaporiser body is achieved already in the heating-up phase of the vaporiser body over the entire vaporiser surface (=subsequent initial wetting surface) provided with the initial wetting auxiliary material, whereby the advantageous aluminium nitride layer is rapidly and reliably formed.

Hence, at the end of the heating-up process of the vaporiser body an aluminium nitride layer already exists over almost the entire vaporiser surface, wherein simultaneously the vapour pressure of the aluminium reaches the pressure of the gas phase or exceeds the same, so that the excessive aluminium of the initial wetting auxiliary material vaporises. The subsequent continuous vaporising of the aluminium to be vaporised therefore takes place from a considerably larger active aluminium bath surface (=vaporiser surface of the vaporiser body captured by the continuously supplied molten aluminium) and at a considerably increased vaporisation rate already at the beginning of the vaporisation process. By means of the obtained large-surface initial wetting by the aluminium of the initial wetting auxiliary material right at the beginning of the heating-up process, also the initial thermal stress of the vaporiser body is reduced, whereby its lifetime is increased and its electrical control is facilitated.

The even and extensive initial wetting furthermore also considerably reduces the so-called splash formation. Splashes are caused, inter alia, by sudden vaporisation of aluminium and form imperfections on the coated substrate. Due to the vaporiser surface being incompletely wetted/coated and due to the pulsating aluminium bath movements, aluminium is constantly supplied from the cooler wetted parts of the vaporiser surface to the hotter unwetted parts of the vaporiser surface, resulting in many small splashes. The even and extensive wetting layer on the vaporiser surface, formed by means of the initial wetting auxiliary material in accordance with the present invention, prevents sudden vaporisation of the aluminium on the vaporiser surface due to temperature gradients, thereby considerably reducing splash formation.

Apart from using the initial wetting auxiliary material for a continuous operation of the vaporiser body or the continuous supply of aluminium to the vaporiser surface, the initial wetting auxiliary material in accordance with the invention may also be used for preparing vaporiser bodies employed in the discontinuous vaporisation of aluminium and coating of non-flexible substrates by means of a flash vaporiser.

The vaporiser body is preferably made of boron nitride as the insulating component and nitrogen supplier for generating the aluminium nitride layer, and of titanium diboride as the electrically conductive component. The boron nitride and the titanium diboride are preferably contained in the vaporiser body material at a ratio of 50 weight % each.

Further, the initial wetting auxiliary material can be easily produced and fixed to the vaporiser body. For example, the initial wetting auxiliary material preferably simply comprises an adhesive, such as an acrylate adhesive, by means of which the initial wetting auxiliary material may be adhesively affixed to the vaporiser surface. However, the initial wetting auxiliary material may also be formed so as to be simply layable onto the vaporiser body, e.g. when being formed as a foil/plate or as a piece, or may be strewable onto the vaporiser body, e.g. when formed as a powder. The initial wetting auxiliary material may also include a combination of a foil/plate material and a power material. The vaporiser body preferably has a cavity in which the foil and/or powder is securely inserted in a loose manner. Alternatively, a wetting agent in powder form is simply strewed or rolled onto the vaporiser surface of the vaporiser body and is then covered by a loosely applied aluminium foil or an aluminium foil affixed by means of an adhesive, or by an aluminium sheet.

Furthermore, the initial wetting auxiliary material preferably comprises tin as an additional material component, wherein the tin may be present in its elementary form or in bound form. The tin, which is preferably provided in powder form having a maximum particle size of 0.02 to 0.06 mm, preferably 0.045 mm, assumes the adhesive properties of the adhesive at temperatures above 230° C. by forming a molten phase, thereby ensuring adhesion/fixation of the initial wetting auxiliary material on the vaporiser surface of the vaporising body also at higher temperatures after the adhesive has decomposed or after the adhesive has vaporised. It is important that the tin assumes the adhesive properties even before the adhesive has vaporised in order to ensure adhesion of the initial wetting auxiliary material over the entire temperature range. Due to its melting temperature and vapour pressure, tin is very well suited for this purpose, since it has, compared to its melting temperature, a relatively low vapour pressure which approximately corresponds to that of aluminium, so that adhesion of the initial wetting auxiliary material on the vaporiser surface is ensured over the entire temperature range of the process by means of the tin in combination with the adhesive. Further, since the vapour pressure of tin approximately corresponds to that of aluminium, towards the end of the heating-up process upon reaching the maximum heating-up temperature the tin vaporises without leaving any residue. The tin may be directly added to the adhesive and/or the wetting agent, and/or may be alloyed to the aluminium. It is pointed out that the invention is not restricted to the use of tin as an adhesive for an increased temperature range, but other material components having a similar temperature range with regard to their melting point and boiling point may also be used. Above all it is important that the chosen material component develops the required adhesive effect prior to the decomposition/evaporation of the adhesive, and that its vapour pressure approximately corresponds to that of aluminium, so that no residues are formed. Although the combination of tin and adhesive offers an almost ideal adhesive effect over the entire temperature range, tin or the adhesive may also be present in the initial wetting auxiliary material without the respective other material component.

Preferably, the wetting agent of the initial wetting auxiliary material contains at least 30 weight %, preferably 40 weight %, of zirconium, molybdenum, titanium or a combination thereof as a material component. The said components may be present in their elementary form, as a metal alloy or bound. In bound form, the components are preferably present as borides and/or silicides and/or nitrides and/or carbides and/or carbonitrides, preferably as boride and/or silicide, but not in an oxidised form. It is important that the compounds, under the heating conditions existing in the metallisation installation, form free titanium metal/molybdenum metal/zirconium metal when in contact with liquid aluminium. Preferably, the wetting agent is titanium diboride, titanium metal, zirconium diboride, zirconium metal, titanium disilicide, zirconium disilicide, molybdenum disilicide, molybdenum metal, ferrous silicon dititanate (FeSiTi₂) or a combination thereof.

The wetting agent e.g. may be formed as a powder, preferably comprising a particle size which is smaller than or equal to 0.2 mm, or may be provided with the aluminium of the initial wetting auxiliary material as an aluminium alloy in the form of an alloy component. The aluminium of the initial wetting auxiliary material e.g. may be formed as an aluminium foil or an aluminium sheet comprising a thickness of 0.0.1 to 4 mm, preferably an aluminium foil comprising a thickness of 0.01 to 0.1 mm or an aluminium sheet comprising a thickness of 0.2 to 0.3 mm, preferably 0.024 to 0.26 mm; according to a preferred embodiment, the wetting agent is applied to the aluminium foil or the aluminium sheet, preferably rolled onto the same. According to another embodiment of the invention, a powder mixture comprising tin and wetting agent is applied to the aluminium foil or aluminium sheet, preferably by rolling on or spraying on the powder mixture. The aluminium may also be provided in powder form, preferably of a particle size which is smaller than or equal to 0.5 mm.

According to another embodiment of the invention, the aluminium of the initial wetting auxiliary material is formed as a foil or a sheet of an aluminium alloy which, apart from the aluminium, contains the wetting agent as an alloy component. As a further alloy component, tin may be alloyed to aluminium. According to an alternative embodiment, the aluminium of the initial wetting auxiliary material and the wetting agent and preferably tin are mixed together to form a powder mixture. In case the aluminium layer is glued to the vaporiser body, e.g. by means of an acrylate adhesive, according to the explanations provided above, the tin prevents the aluminium foil or the aluminium sheet form being lifted off the vaporiser due to the adhesive melting and vaporising or decomposing during operation, since the tin in its molten state possesses sufficient adhesive properties. Alternatively, a porous aluminium foil or a porous aluminium sheet might be provided, through which the adhesive vapour may escape without the foil or sheet being lifted off.

According to yet another embodiment, the initial wetting auxiliary material is formed as a suspension of liquid adhesive, preferably organic adhesive or wax, in which is dispersed the powder mixture of aluminium, wetting agent and preferably tin. This allows the initial wetting auxiliary material to be formed as a layer by means of simply laying the same on the vaporiser body. The liquid adhesive forms a matrix, preferably an organic matrix, in which the powder mixture is integrated. According to a preferred embodiment, the suspension e.g. comprises paraffin stearate wax, titanium and/or titanium diboride powder of a maximum particle size of 0.015 mm, aluminium powder of a maximum particle size of 0.5 mm and preferably tin powder of a maximum particle size of 0.02 to 0.06 mm, preferably 0.045 mm. The wax e.g. is heated up to a temperature of about 150° C., and the aluminium, the wetting agent and, if applicable, the tin are stirred into the hot wax, thereby producing the suspension. In this heated state, the wax suspension may then be applied to the vaporiser, preferably into a cavity of the vaporiser. Subsequently the wax suspension is solidified by cooling down, so that the vaporiser body prepared in this way may be delivered/shipped. Preferably, the suspension therefore has a melting point of above 70° C. In addition, the solidified wax suspension may be provided with an embossment for the purpose of transmitting information, e.g. operation instructions or advertisements. When heating up the vaporiser body, the wax melts and vaporises or decomposes, so that at first there remains the aluminium and the wetting agent forming the aluminium nitride layer as well as, if applicable, the tin, wherein the tin is finally vaporised together with the remaining aluminium. According to another preferred embodiment, the suspension e.g. comprises aluminium powder, titanium and/or titanium diboride powder, sugar, glycol and preferably tin. In case suspensions are used which do not solidify at room temperature, or if loose powder is used as the initial wetting auxiliary material, the vaporiser body prepared therewith may e.g. be provided with a self-adhesive foil or another cover preventing the suspension or powder from getting out of a cavity in the vaporiser body during transport. The cover may e.g. be sensitive to heat, so that it is automatically destroyed during operation of the vaporiser body, or it may be detachable, e.g. in the form of a peelable foil.

The initial wetting auxiliary material itself may be a multi-layer structure, e.g. of an aluminium layer, a wetting agent layer extensively applied to the aluminium layer, preferably a tin powder layer applied to the wetting agent layer, and an adhesive layer applied to the wetting agent layer or tin powder layer, by means of which the initial wetting auxiliary layer is applied to the vaporiser body like an adhesive label. The adhesive of the adhesive layer is preferably selected in such a way that it decomposes during heating of the vaporiser body at a temperature of 250° C. or above and vaporises entirely, i.e. almost without leaving any residue. Such an adhesive is, e.g. acrylate adhesive. The tin powder, as described above, assumes the adhesive properties by producing a molten mass at temperatures above 230° C., wherein the transition of the adhesive properties takes place in a fluent or overlapping manner, i.e. in a temperature range of about 230° C. to about 260° C. the adhesion/fixation of the initial wetting auxiliary-material on the vaporiser surface takes effect by means of the adhesive and the molten tin mass. The tin powder is preferably simply mixed with the adhesive, so that a separate tin layer is not required.

According to an embodiment of the invention, the initial wetting auxiliary material is formed as a dual layer comprising a first layer comprising a mixture of an organic acrylate adhesive and the wetting agent and preferably tin powder, and a second layer comprising aluminium or an aluminium alloy, wherein the thickness of the second layer is preferably greater than the thickness of the first layer. In this case the thickness of the first layer is preferably 0.02-0.06 mm, more preferably 0.050 mm, wherein the wetting agent is titanium or titanium diboride powder of a particle size of 0.01-0.02 mm, preferably 0.015 mm, and is contained in the first layer at a weight percentage of 15-40 weight %, preferably 30 weight %, and wherein the tin powder is contained in the first layer at a weight percentage of 5-30 weight %, preferably 30 weight %. The thickness of the second layer is 0.045-4 mm, preferably 0.045-0.1 mm, more preferably 0.055, or 0.2-0.3 mm, more preferably 0.24-0.26 mm.

According to another embodiment of the invention, the aluminium of the initial wetting auxiliary material is formed as an aluminium piece, preferably as an aluminium wire piece, an aluminium cube or in the form of a lens. In addition to aluminium, the aluminium piece preferably also comprises the wetting agent as a component, wherein the wetting agent is a material which cannot be alloyed to aluminium. The wire piece may e.g. be bent in the shape of a meander and may be glued or laid onto the vaporiser body.

Alternatively, according to the invention, the aluminium may also be formed as a material piece of an aluminium alloy, preferably as a wire material piece, an ashlar body or in the form of a lens, the aluminium alloy containing the wetting agent and, if applicable, tin as an alloy component in addition to aluminium.

The aluminium alloy preferably contains 90-97 weight % of metallic aluminium, including impurities, and 3-10 weight % of titanium as a wetting agent.

According to another embodiment of the invention, the initial wetting auxiliary material is formed as a triple or three-coat layer, comprising a first layer formed by the aluminium foil or the aluminium sheet, a second layer of wetting agent deposited on the first layer, and a third layer of an adhesive, preferably acrylate adhesive, deposited on the wetting agent layer. Here, the second layer is fixed to the surface of the first layer e.g. by rolling on 0.05 g titanium and/or titanium diboride and 0.03-0.05 g tin, preferably 0.05 g, wherein the thickness of the adhesive layer is 0.02-0.06 mm, preferably 0.03 mm, and wherein the total thickness of the adhesive label is 0.1-4 mm, preferably 0.10-0.16 mm, more preferably 0.13 mm, or 0.25-0.35 mm. Preferably, tin powder, preferably of a maximum particle size of 0.02-0.06 mm, more preferably 0.045 mm, is added to the wetting agent and/or the adhesive.

According to an embodiment of the invention, the adhesive is an adhesive layer, preferably of acrylate adhesive, of a thickness of 0.02-0.06 mm, preferably 0.03-0.05 mm, and the total thickness of the initial wetting auxiliary material is 0.07-4 mm, preferably 0.07-0.16 mm, more preferably 0.10-0.13 mm, or 0.2-0.35 mm. These thickness dimensions have proved to be sufficient with regard to the desired distribution and sufficient formation of an aluminium nitride layer, wherein the adhesive decomposes and vaporises at a sufficient speed, but not until initiation of the adhesive properties by means of the liquid tin, and wherein a sufficiently strong adhesive effect is effected by the adhesive prior to the adhesive properties of the tin starting to take effect.

Preferably, according to the present invention, the initial wetting auxiliary material is also used as an information carrier, for which purpose it can be provided with an embossment or an imprint. In this way, e.g. properties or other labellings, such as advertisements and trademarks, may be placed on the initial wetting auxiliary material. For applying an embossment, preferably the solidified wax suspension as well as the aluminium foil or aluminium sheet is suited; the latter are also preferably suited for applying an imprint.

The invention further provides a vaporiser body, electrically heatable by means of direct current passage, preferably a ceramic vaporiser body, the vaporiser body comprising a vaporiser surface for operation in a PVD metallisation installation for vaporising aluminium. As a material component, the vaporiser body contains nitrogen, preferably in the form of boron nitride, and is provided with an initial wetting auxiliary material in accordance with the invention which is applied to the vaporiser surface, preferably to the entire vaporiser surface.

As briefly mentioned above, the vaporiser body preferably is a mixed ceramic comprising titanium diboride and boron nitride as major components, with a respective mixing ratio of 50 weight % plus/minus 10 weight %. In accordance with the invention, the vaporiser body may comprise a cavity in which the suspension-like, powdery or foil-shaped initial wetting auxiliary material is inserted, the initial wetting auxiliary material preferably being covered by a removable or heat-sensitive cover.

The vaporiser body comprises a vaporiser surface. The vaporiser surface may be preferably occupied entirely or partially with an initial wetting auxiliary material in accordance with the invention.

According to a preferred embodiment, the used mass of wetting agent in relation to the vaporiser surface of the vaporiser body is 0.3 to 400 mg/cm²_{vaporiser surface}, preferably 1 to 6 mg/cm²_{vaporiser surface}, and that of aluminium is 0.1 to 100 mg/cm²_{vaporiser surface}, preferably 10 to 60 mg/cm²_{vaporiser surface}.

The invention further provides a method for preparing a vaporiser body, preferably a ceramic vaporiser body which is heatable by direct current passage, said vaporiser body being provided for operation in a PVD metallisation installation for vaporising aluminium and containing as a material component nitrogen, preferably in the form of boron nitride. An initial wetting auxiliary material according to the invention is at least partially applied to the vaporiser surface of the vaporiser body, preferably substantially over the entire surface, prior to heating the vaporiser body. When used, the vaporiser body according to the invention is operated using electric current in order to melt the aluminium of the initial wetting auxiliary material and to distribute the same extensively on the vaporiser surface by means of the wetting agent, whereby the aluminium of the molten initial wetting auxiliary material reacts with the nitrogen component of the vaporiser body, thereby forming an aluminium nitride layer on which the aluminium material to be actually vaporised is then applied.

According to the above method, the initial wetting auxiliary material is preferably inserted in a cavity of the vaporiser body in the form of a suspension. Also, the suspension may be applied to the vaporiser surface of the vaporiser body with a thickness of 0.05-2.0 mm, preferably is 0.1-0.2 mm. Preferably a suspension with a melting point exceeding the temperature of 70° C. is used, so that the suspension may be solidified by cooling down the same after application of the same to the vaporiser surface of the vaporiser body or after insertion of the same into the cavity of the vaporiser body. This makes it possible to provide an embossment on the surface of the wax layer for transmitting information, and allows an unproblematic delivery/shipping of the vaporiser body provided with the initial wetting auxiliary material.

The invention is explained below on the basis of preferred embodiments by reference to the drawings. In the drawings:

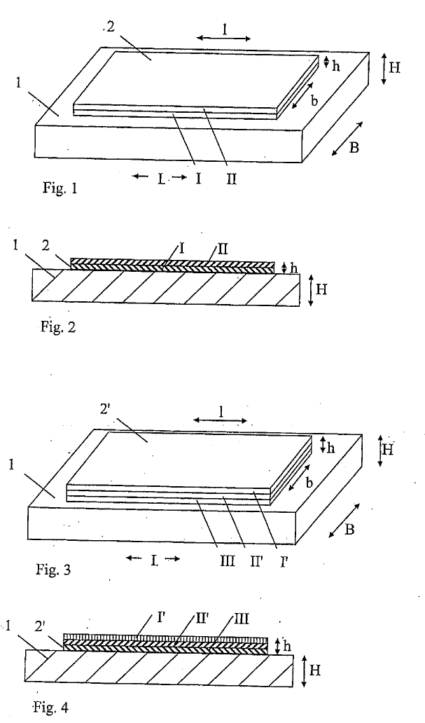

FIG. 1 is a perspective view of a vaporiser body having an initial wetting auxiliary material in accordance with a first embodiment of the invention,

FIG. 2 is a cross-sectional view of a vaporiser body having an initial wetting auxiliary material in accordance with the first embodiment of the invention.

FIG. 3 is a perspective view of a vaporiser body having an initial wetting auxiliary material in accordance with another embodiment of the invention,

FIG. 4 is a cross-sectional view of a vaporiser body having an initial wetting auxiliary material in accordance with the embodiment of the invention shown in FIG. 3,

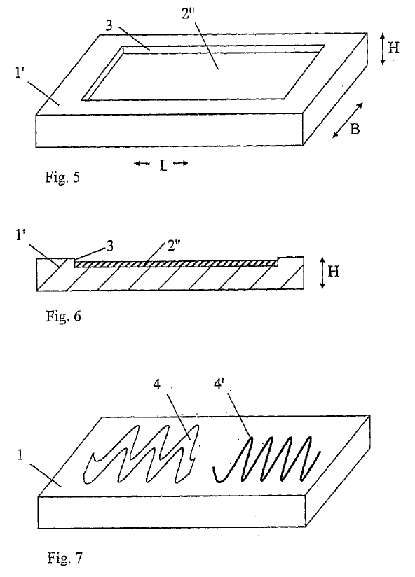

FIG. 5 is a perspective view of a vaporiser body having an initial wetting auxiliary material in accordance with yet another embodiment of the invention,

FIG. 6 is a cross-sectional view of a vaporiser body having an initial wetting auxiliary material in accordance with the embodiment of the invention shown in FIG. 5, and

FIG. 7 is a perspective view of a vaporiser body having an initial wetting auxiliary material in accordance with yet another embodiment of the invention.

FIG. 1 and FIG. 2 show a vaporiser body 1 having an initial wetting auxiliary material in accordance with a first embodiment of the invention. Vaporiser body 1 is designed in the form of a so-called vaporiser boat and consists of hot-pressed ceramic material containing titanium diboride and boron nitride as major components, wherein titanium diboride is the electrically conductive component and boron nitride is the electrically insulating component. The mixing ratio of conductive and non-conductive components is 50 weight % each (+/−10 weight %), which results in a specific resistance of approximately 600-6000 μOhm*cm. E.g., the vaporiser body has a length L of approximately 130 mm, a width B of approximately 30 mm and a height H of approximately 10 mm.

The vaporiser body is preferably resistance-heated directly, i.e. in a direct current passage. However, it may also be heated indirectly, i.e. by means of an external heating source.

The initial wetting auxiliary material according to the first embodiment of the invention is formed as a multi-layer structure and is deposited on the upper surface of vaporiser body 1 forming the vaporiser surface. The initial wetting auxiliary material has a length 1 of approximately 100 mm, a width b of approximately 28 mm and a height h of 0.105-0.4 mm. The multi-layer structure shown in FIG. 1 and FIG. 2 is a dual layer 2 comprising a first layer I and a second layer II.

The first layer I of dual layer 2 is formed as an adhesion layer and consists of an adhesive layer of a thickness of 0.02-0.06 mm, preferably 0.03-0.05 mm, to which titanium and/or titanium diboride powder is added at a weight percentage of 15-40 weight %, preferably 30 weight %. The titanium and/or titanium diboride powder has a maximum particle size of 0.01-0.02 mm, preferably 0.015 mm. Preferably, tin powder is additionally added to the adhesion layer at a weight percentage of 5-30 weight %, preferably 30 weight %, wherein the tin powder has a maximum grain size of 0.06 mm, exemplarily 0.045 mm. The titanium and/or titanium diboride powder serves as a wetting agent, wherein alternatively zirconium diboride, zirconium, titanium disilicide, zirconium disilicide, molybdenum disilicide, molybdenum or ferro silicon dititanate (FeSiTi₂) can be used as the wetting agent and added to the adhesive layer. As an adhesive, organic acrylate adhesive is used, but the invention is not restricted to the use of organic acrylate adhesive as an adhesive. At temperatures of above 230° C., the tin functions as an ‘adhesive’ by forming a molten mass, thereby replacing the adhesive at higher temperatures, the adhesive vaporising at approximately 250° C. The vapour pressure of tin and aluminium is approximately the same, so that the tin vaporises entirely, i.e. without leaving any residue.

The second layer II of dual layer 2 has a thickness of 0.045-4 mm, preferably 0.045-0.1 mm, more preferably 0.055 mm, or 0.2-0.3 mm, more preferably 0.24-0.26 mm, and contains aluminium as the major component. The aluminium is preferably provided in the form of an aluminium foil or aluminium sheet comprising a length of 100 mm and a width of 28 mm, but may also be formed as a foil or a sheet of an aluminium alloy which in addition to the aluminium contained at a ratio of approximately 90-97 weight % contains approximately 3-10 weight % of a wetting agent e.g. titanium. Tin may also be added to the alloy as an alloy component.

The initial wetting auxiliary material according to the first embodiment of the invention is glued to the surface of the vaporiser body 1 forming the vaporiser surface like an adhesive label by means of the first layer I formed as an adhesion layer. The initial wetting auxiliary material is preferably extensively and centrally applied to the surface of vaporiser body 1, in order to prevent the molten aluminium or the wetting agent from laterally flowing down, or to reduce such flow. The adhesive of the first layer I, by means of which the initial wetting auxiliary material is applied to vaporiser body 1 like an adhesive label, is preferably selected in such a way that during the heating of the vaporiser body 1 it decomposes and entirely vaporises, i.e. almost without leaving any residue, wherein the decomposition temperature of the adhesive preferably is approximately 250° C. or higher. Shortly before decomposition of the adhesive, the tin starts to melt and assumes the adhesive properties of the adhesive. Above all, this is important in cases in which the second layer II of the dual layer 2 is formed as a foil/sheet or powder. In this case, the tin cast prevents the foil or sheet or single powder particles from being lifted or carried away by rising gas bubbles of the decomposing adhesive. It is vital that the tin has already developed its full adhesive properties before the decomposition temperature of the adhesive has been reached. In addition or alternatively, a perforated foil or perforated sheet can be provided, so that the vaporising adhesive may escape without lifting the foil.

Vaporiser body 1 comprising dual layer 2 deposited on the surface or vaporiser surface thereof is then preferably resistance-heated in a metallisation installation under high-vacuum, and heated to a temperature of approximately 1450 to 1600° C. At the beginning of the heating process the acrylate adhesive of the first layer I of the initial wetting auxiliary material decomposes, and then the aluminium of the second layer II of the initial wetting auxiliary material begins to melt. The liquid aluminium is evenly distributed on the vaporiser surface by means of the wetting agent, here titanium and/or titanium diboride, due to the small wetting angle in relation to the vaporiser surface of vaporiser body 1, and may hence react on the entire previously laminated vaporiser surface in situ with the boron nitride of vaporiser body 1 to form aluminium nitride. The formation of aluminium nitride during the heating-up process is advantageous, because aluminium nitride is far better wetted by aluminium than the boron nitride of vaporiser body 1. At the end of the heating-up process the vapour pressure of the aluminium is also reached, i.e. the vapour pressure of the aluminium is equal to or greater than the pressure of the gas phase, so that the aluminium vaporises. All that remains of the initially applied initial wetting auxiliary material on the vaporiser surface of vaporiser body 1 is titanium/titanium boride.

Aluminium, e.g. in the form of an aluminium wire, is then continuously supplied to the aluminium nitride layer generated during the heating-up process and the titanium/titanium boride residue of the initial wetting auxiliary material. Due to the aluminium nitride layer, the continuously supplied aluminium is evenly distributed on the vaporiser surface of vaporiser body 1, wherein approximately 80% of the surface of vaporiser body 1, to which the initial wetting auxiliary material formed as a dual layer is glued, is wetted by aluminium. This leads to a high initial vaporising rate already at the beginning, and the initial vaporising rate does not have to be set lower than the desired target vaporising rate. The wetting agent, here titanium/titanium diboride, is not vaporised and hence is left as a residue on the vaporiser surface of vaporiser body 1. Further advantages, resulting from an improved initial wetting of the aluminium on the ceramic vaporiser body 1, are a reduced initial thermal stress impacting on vaporiser body 1 and a larger and even wetting surface also beyond the initial wetting phase, whereby the lifetime of vaporiser body 1 is increased and the electrical control of vaporiser body 1 is improved.

FIG. 3 and FIG. 4 show a second embodiment of the invention. The shown vaporiser body 1 corresponds to the vaporiser body described above and shown in FIG. 1, i.e. the dimensions and the composition of the vaporiser body shown in FIG. 1 and FIG. 3 are identical, for which reason the same reference numerals are used.

According to the second embodiment of the invention, an initial wetting auxiliary material, again formed as a multi-layer structure, is applied to the upper surface of vaporiser body 1 which forms the vaporiser surface. The initial wetting auxiliary material in accordance with the second embodiment of the invention preferably has a length l of approximately 100 mm, a width b of approximately 28 mm and a height h of approximately 0.1 to 4 mm, and is a triple layer 2′ comprising a first layer I′, a second layer II′ and a third layer III.

The first layer I′ of the triple layer 2′ contains aluminium as the major component, wherein the aluminium is preferably provided in the form of an aluminium foil or an aluminium sheet, but may also be formed as a foil or a sheet comprising an aluminium alloy which, in addition to the aluminium contained at a ratio of approximately 90-97 weight %, also contains a wetting agent, e.g. titanium, at a ratio of approximately 3-10 weight %. In addition to the wetting agent, tin may be alloyed to the foil, which serves as an adhesive at temperatures of above 230° C. as described above.

Second layer II′ consists of a wetting agent, here titanium and/or titanium diboride, which is provided in powder form and applied to the first layer I′. The wetting agent is preferably rolled onto the first layer I′ in order to fix the same on the first layer I′ or in order to coat the first layer I′ with the wetting agent. A total of 0.05 g titanium and/or titanium diboride is fixed to the surface of the first layer I′ by rolling. Alternatively, zirconium diboride, zirconium, titanium disilicide, molybdenum, ferro silicon dititanate (FeSiTi₂), molybdenum disilicide or zirconium disilicide is used as wetting agents.

Third layer III of triple layer 2′ is formed as an adhesion layer and consists of an adhesive layer the thickness of which ranges from 0.02 to 0.06 mm, preferably 0.03 mm, the adhesive layer being arranged below first layer I′ and second layer II′, wherein the total thickness of the initial wetting auxiliary material is 0.1-4 mm, preferably 0.10-0.16 mm, more preferably 0.13 mm, or 0.25-0.35 mm. As the adhesive, organic acrylate adhesive is used here, but the invention is not restricted to the use of organic acrylate adhesive as an adhesive.

Preferably, tin powder of a maximum particle size of 0.02 to 0.06 mm is added to the wetting agent and/or the adhesive. E.g. 0.05 g of titanium/titanium diboride and 0.05 g of tin may be mixed and applied to the first layer I′ by rolling or by another method.

The initial wetting auxiliary material according to the second embodiment of the invention is adhesively affixed to the surface of vaporiser body 1 like an adhesive layer, by means of third layer III which is formed as an adhesion layer. The adhesive of the third layer III is selected in such a way that it decomposes and vaporises entirely, i.e. almost without leaving any residue, during heating of the vaporiser body 1, wherein tin replaces the adhesive properties of the adhesive at temperatures of above 230° C. Vaporiser body 1 comprising the adhesively affixed initial wetting auxiliary material is preferably resistance-heated in a metallisation installation under high vacuum as described above and is thus heated to a temperature of approximately 1450 to 1600° C. The heating-up process and the result are in correspondence with the description of the first embodiment of the invention.

Besides, it is possible to omit the third layer III of the triple layer 2′ and to instead lay the initial wetting auxiliary material on vaporiser body 1, preferably into a cavity formed on the upper side of vaporiser body 1, rather than adhesively affixing the initial wetting auxiliary material to vaporiser 1 body 1.

Further, as an alternative to the aluminium foil/aluminium sheet or the aluminium alloy foil/aluminium alloy sheet, a piece of an aluminium wire may be used which is coated with the wetting agent, preferably titanium and/or titanium diboride, and laid onto the vaporiser surface of vaporiser body 1, preferably into a cavity formed on the upper side of vaporiser body 1 and/or which is adhesively affixed to the vaporiser surface of vaporiser body 1 by means of an adhesive. The aluminium wire is preferably bent in the shape of a meander and placed on the vaporiser surface so that it occupies or covers as large a part of the vaporiser surface as possible. However, even in this way the vaporiser surface cannot be entirely covered with the initial wetting auxiliary material, so that with regard to an initial wetting or coating of the vaporiser body which is as rapid and extensive as possible, the formation of the initial wetting auxiliary material as an adhesive label in accordance with the first or second embodiment of the invention is to be preferred to this embodiment.

According to a third embodiment of the invention which is not shown, an initial wetting auxiliary material is provided which is formed as an adhesive label and is adhesively affixed to the surface or vaporiser surface of the vaporiser body. The vaporiser body to be used corresponds to the vaporiser body described above. The initial wetting auxiliary material in accordance with the third embodiment of the invention preferably has a length of approximately 100 mm, a width of approximately 28 mm and a height of approximately 0.1-4 mm and is formed as a dual layer comprising a first layer and a second layer, similar to the first embodiment of the invention.

The first layer of the initial wetting auxiliary material in accordance with the third embodiment of the invention is an adhesion layer of organic acrylate adhesive with a thickness of 0.02-0.06 mm, preferably 0.03 mm, wherein the invention is not restricted to the use of an acrylate adhesive. As described above, the adhesive is selected such that when the vaporiser body is heated it decomposes and vaporises entirely, i.e. almost without leaving any residue. As described above, tin may also be added to the adhesive.

The second layer of the initial wetting auxiliary material in accordance with the third embodiment of the invention comprises aluminium in the form of a foil or an aluminium sheet comprising an aluminium alloy which in addition to aluminium comprises a wetting agent as an alloy component, wherein the aluminium wetting agent alloy comprises 90-97 weight % of metallic aluminium, including impurities, and 3-10 weight % of a wetting agent. The wetting agent preferably is titanium which is alloyed to the aluminium; however, also another wetting agent, e.g. zirconium, may be alloyed to aluminium. Furthermore, tin may also be alloyed to the aluminium as a further alloy component. The vaporiser body provided with the initial wetting auxiliary material in accordance with the third embodiment of the invention is preferably resistance-heated to a temperature of approximately 1450-1600° C. in a metallisation installation under high vacuum. The heating-up process and the result are in correspondence with the description of the first embodiment of the invention.

Alternatively, according to a fourth embodiment of the invention which is not shown, a material piece, e.g. a wire material piece, a material cube or material pressed in the form of a lens, comprising an aluminium alloy which in addition to aluminium contains a wetting agent as an alloy component may be provided and may be either glued to the vaporiser surface of the vaporiser body by means of an adhesion layer or an adhesive agent layer and/or may be inserted into a cavity formed on the surface of the vaporiser body. The material piece is preferably formed and deposited on the vaporiser body in such a way that it covers as large a part of the vaporiser surface as possible. As a further alloy component, tin may also be alloyed to the aluminium.

FIG. 5 and FIG. 6 show a fifth embodiment of the invention comprising a vaporiser body 1′. With regard to the dimensions and its composition, vaporiser body 1′ corresponds to vaporiser body 1 described above; however, vaporiser body 1′ comprises a cavity 3 on the surface forming the vaporiser surface. Cavity 3 e.g. has a length of approximately 100 mm, a width of approximately 26 mm and a height of approximately 1 mm. Cavity 3 in FIG. 5 and FIG. 6 comprises a rectangular cross section, but cavity 3 may also comprise another form of cross section, e.g. a circular cross section. Further, the delimitating areas of cavity 3, in this case respectively shown as a planar and perpendicular delimitating area, may be formed as inclined or curved delimitating areas, so that residues remaining in the cavity or on the vaporiser body may be removed without difficulty.

According to the fifth embodiment of the invention, the initial wetting auxiliary material is provided in the form of a suspension 2″, preferably in the form of a hot wax suspension of 150° C., which is filled into cavity 3 of vaporiser body 1′, wherein a powdery mixture of aluminium and a wetting agent is contained in suspension 2″. Suspension 2″ contains e.g. 95-105 g, preferably 100 g, of paraffin stearate wax as an organic matrix (e.g. wax or adhesive), into which are stirred between 1.5 and 2.5 g, preferably 2.0 g, of titanium and/or titanium diboride powder of a maximum particle size ranging from 0.01-0.02 mm, preferably 0.015 mm, and 10-20 g, preferably 15 g, of aluminium powder of a maximum particle size ranging from 0.4-0.6 mm, preferably 0.5 mm, preferably at a temperature of 150° C., so that the mixture of wetting agent and aluminium is finely distributed in suspension 2″ or is embedded in the organic matrix. Preferably, tin is also added to the suspension 2″.

Vaporiser body 1′ is heated to a temperature of 1450-1600° C. in > a metallisation installation as described above. At the beginning of the heating-up process, the organic matrix, in this case wax, vaporises, and the mixture of wetting agent and aluminium and, if applicable, tin remains in cavity 3 of the vaporiser body. The following processes occurring during the heating-up process and the results thereof correspond to the heating-up process described in connection with the first embodiment of the invention.

In accordance with a sixth embodiment of the invention which is not shown, a suspension comprising glycol, an organic adhesive, titanium/titanium diboride powder and aluminium powder and having a layer thickness ranging from 0.01-2 mm, preferably 0.1-0.2 mm, is applied to the vaporiser surface of the vaporiser body as an initial wetting auxiliary material. The vaporiser body preferably corresponds to the vaporiser body used in the first embodiment of the invention, but it may also comprise a cavity in accordance with vaporiser body 1′. 100 g suspension contain 50 g aluminium powder (d90<0.05 mm), 7 g titanium/titanium diboride powder (d90<13 mm), 5 g sugar and 38 g glycol. Preferably, the suspension also contains tin powder.

Hence the initial wetting auxiliary material according to the sixth embodiment of the invention may be applied to the vaporiser body by simply coating it thereon. Alternatively, the suspension may be inserted into the cavity formed on the vaporiser surface of the vaporiser body.

FIG. 7 shows a seventh embodiment of the invention according to which the aluminium of the initial wetting auxiliary material is provided in the form of an aluminium piece, preferably in the form of an aluminium strip piece 4 or an aluminium wire piece 4′ which is preferably bent in the shape of a meander, wherein the aluminium piece comprises the wetting agent as a component in addition to aluminium, wherein the wetting agent is a material which cannot be alloyed with aluminium. Furthermore, tin may be alloyed to the aluminium as an alloy component. The wetting agent, e.g. titanium diboride powder, is added to the aluminium piece which, as shown in FIG. 7, is simply loosely laid onto the vaporiser surface of vaporiser body 1 or is inserted into a cavity formed on the vaporiser surface of vaporiser body 1 for a better stability. Alternatively, the mixture of the aluminium piece and the wetting agent may be adhesively affixed to the vaporiser surface of vaporiser body 1 by means of an adhesive to which tin is preferably added. Also in this case, the aluminium piece is preferably deposited on the vaporiser surface in such a manner that it occupies or covers as large a part of the vaporiser surface as possible; however, with this embodiment of the invention the vaporiser surface of the vaporiser body cannot be entirely covered by the initial wetting auxiliary material, in contrast to those embodiments in which the initial wetting auxiliary material is applied to the vaporiser surface as an adhesive label or a suspension.

In the embodiments 2 to 7 described above the initial wetting auxiliary material may be deposited on the vaporiser surface of the vaporiser body by means of an adhesion layer or adhesive agent layer and/or may be inserted into a cavity formed on the surface of the vaporiser. Furthermore, the choice of the wetting agent is not restricted to titanium diboride and titanium. Metal alloys containing zirconium and/or molybdenum and/or titanium, zirconium, zirconium diboride, titanium disilicide, molybdenum, zirconium disilicide, molybdenum disilicide, ferro silicon dititanate (FeSiTi₂) are further wetting agents which may be used. As a general rule, the wetting agent contains at least 30 weight %, preferably 40 weight %, of zirconium, molybdenum, titanium or a combination thereof as a material component. The said components may be present in elementary form, as a metal alloy or in bound form, e.g. as a boride or silicide. Furthermore the components may be present as nitrides, carbonates or carbon nitrides. Oxides of metals are not suitable. The compounds have in common that they can form free titanium metal/molybdenum metal/zirconium metal under the heating conditions present in the metallisation installation when in contact with liquid aluminium. If used as a powder, the wetting agent is generally provided with a particle size of 0-0.2 mm. The aluminium source may be an aluminium foil or an aluminium sheet of a thickness ranging from 0.01-4 mm, preferably an aluminium foil of a thickness ranging from 0.01 to 0.1 or an aluminium sheet of a thickness ranging from 0.2-0.3 mm, an aluminium powder of a particle size which is smaller than or equal to 0.5 mm, or an aluminium piece. The mass of wetting agent used relative to the vaporiser surface of the vaporiser body ranges from 0.3 to 400 mg/cm²_{vaporiser surface}, preferably 1 to 6 mg/cm²_{vaporiser surface}, and that of the aluminium ranges from 0.1 to 100 mg/cm²_{vaporiser surface}, preferably 10 to 60 mg/cm²_{vaporiser surface}.

Furthermore, the initial wetting auxiliary material in accordance with the invention may be preferably used as an information carrier, wherein e.g. properties, labels or advertisements and trademarks may be provided on the initial wetting auxiliary material. Above all, this applies to those embodiments in which the top layer of the initial wetting auxiliary material is an aluminium foil/an aluminium sheet which is provided with a imprint or an embossment. In the case of a powder mixture comprising aluminium and a wetting agent, which is dispersed in wax, the wax may be embossed.

1-36. (canceled)

37. An initial wetting auxiliary material for applying to a vaporiser surface of an electrically heatable ceramic vaporiser body, the vaporiser body being used for operation in a physical vapour deposition (PVD) metallisation installation for vaporising aluminium, the vaporiser body containing nitrogen as a material component, the auxiliary material comprising:
a powder mixture comprising:
(a) aluminium in powder form having a particle size which is at most 0.6 mm, the aluminium in powder form melting on the vaporiser surface after initiating the operation of the vaporiser body and reacting with the nitrogen of the vaporiser body to form an aluminium nitride layer on the vaporiser surface; and
(b) a wetting agent in powder form promoting an even and large-surface distribution of the molten aluminium on the vaporiser surface.

38. The initial wetting auxiliary material according to claim 37, wherein the wetting agent has a particle size which is at most 0.2 mm.

39. The initial wetting auxiliary material according to claim 37, further comprising:
an adhesive affixing the initial wetting auxiliary material on the vaporiser surface.

40. The initial wetting auxiliary material according to claim 37, further comprising:
tin as a material component, the tin being in one of an elementary form and a bound form.

41. The initial wetting auxiliary material according to claim 37, wherein a ratio between a mass of the wetting agent and an area density of the vaporiser surface of the vaporiser body is 0.3 to 400 mg/cm², and wherein a ratio between a mass of the aluminium and an area density of the vaporiser surface of the vaporiser body is 0.1 to 100 mg/cm².

42. The initial wetting auxiliary material according to claim 37, wherein the wetting agent includes as a material component of at least 30 weight % of one of zirconium, molybdenum, titanium and a combination thereof, the material component of the wetting agent being in one of an elementary form and a bound form.

43. The initial wetting auxiliary material according to claim 37, wherein the wetting agent is one of titanium diboride, titanium, zirconium diboride, zirconium, titanium disilicide, zirconium disilicide, molybdenum disilicide, molybdenum and ferrous silicon dititanate (FeSiTi₂).

44. The initial wetting auxiliary material according to claim 40, wherein the tin is in powder form with a maximum particle size of 0.02 to 0.06 mm and is added to the wetting agent.

45. The initial wetting auxiliary material according to claim 37, wherein the auxiliary material is formed as a suspension of a liquid adhesive in which the powder mixture is dispersed.

46. The initial wetting auxiliary material according to claim 39, wherein the adhesive is an adhesion layer having a thickness of 0.02-0.06 mm.

47. The initial wetting auxiliary material according to claim 45, wherein the suspension comprises (a) paraffin stearate wax, (b) at least one of titanium and titanium diboride powder having a maximum particle size of 0.015 mm, and (c) aluminium powder having a maximum particle size of 0.5 mm.

48. The initial wetting auxiliary material according to claim 45, wherein the suspension contains (a) aluminium powder, (b) at least one of titanium and titanium diboride powder, (c) sugar and (d) glycol.

49. An initial wetting auxiliary material for applying to a vaporiser surface of an electrically heatable ceramic vaporiser body, the vaporiser body being used for operation in a PVD metallisation installation for vaporising aluminium, the vaporiser body containing nitrogen as a material component, the auxiliary material comprising:
a material being one of a foil material and a sheet material, the material comprising one of aluminium and an aluminium alloy, the material melting after initiating the operation of the vaporiser body and reacting with the nitrogen of the vaporiser body to form an aluminium nitride layer on the vaporiser surface, and
a wetting agent one of (a) alloyed to, (b) applied to and (c) alloyed to and applied to the material promoting an even and large-surface distribution of the molten aluminium on the vaporiser surface.

50. The initial wetting auxiliary material according to claim 49, wherein the wetting agent is formed as a powder and applied to the foil material.

51. The initial wetting auxiliary material according to claim 50, wherein the wetting agent has a particle size which is at most 0.2 mm.

52. The initial wetting auxiliary material according to claim 49, further comprising:
an adhesive affixing the auxiliary material on the vaporiser surface.

53. The initial wetting auxiliary material according to claim 49, further comprising:
tin as a material component, the tin being in one of an elementary form and a bound form.

54. The initial wetting auxiliary material according to claim 49, wherein a ratio between a mass of the wetting agent and an area density of the vaporiser surface of the vaporiser body is 0.3 to 400 mg/cm², and wherein a ratio between a mass of the aluminium and an area density of the vaporiser surface of the vaporiser body is 0.1 to 100 mg/cm².

55. The initial wetting auxiliary material according to claim 49, the wetting agent includes as a material component of at least 30 weight % of one of zirconium, molybdenum, titanium and a combination thereof, the material component of the wetting agent being in one of an elementary form and a bound form.

56. The initial wetting auxiliary material according to claim 49, wherein the wetting agent is one of titanium diboride, titanium, zirconium diboride, zirconium, titanium disilicide, zirconium disilicide, molybdenum disilicide, molybdenum and ferrous silicon dititanate (FeSiTi₂).

57. The initial wetting auxiliary material according to claim 53, wherein the tin is in powder form with a maximum particle size of 0.02 to 0.06 mm and is added to the wetting agent.

58. The initial wetting auxiliary material according to claim 49, wherein the foil material has a thickness of 0.01 mm to 4 mm.

59. The initial wetting auxiliary material according to claim 49, wherein the wetting agent is rolled onto the foil material.

60. The initial wetting auxiliary material according to claim 57, wherein the mixture of the wetting agent and the tin powder is rolled onto the foil material.

61. The initial wetting auxiliary material according to claim 49, wherein, when the wetting agent is alloyed to the foil material, the foil material further includes tin as an alloy component.

62. The initial wetting auxiliary material according to claim 49, wherein the auxiliary material is formed as a dual layer comprising (a) a first layer of a mixture of organic acrylate adhesive and the wetting agent and (b) a second layer formed by the foil, the thickness of the second layer being greater than the thickness of the first layer.

63. The initial wetting auxiliary material according to claim 62, wherein the first layer has a thickness of 0.02-0.06 mm, the wetting agent is at least one of titanium and titanium diboride powder having a maximum particle size of 0.01-0.02 mm and contained in the first layer at a weight percentage of 15-40 weight %, the tin powder is contained in the first layer at a weight percentage of 5-30 weight %, and the second layer has a thickness of 0.045-4 mm.

64. The initial wetting auxiliary material according to claim 49, wherein, when the wetting agent is alloyed to the foil material, the foil material comprises 90-97 weight % of metallic aluminium including impurities, and 3-10 weight % of titanium as a further the wetting agent.

65. The initial welting auxiliary material according to claim 49, wherein the auxiliary material is formed as a triple layer comprising (a) a first layer formed by the foil, (b) a second layer deposited on the first layer and comprising the wetting agent, and (c) a third layer deposited on the second layer and comprising an adhesive.

66. The initial wetting auxiliary material according to claim 65, wherein the second layer is fixed on the surface of the first layer by rolling thereon a mixture of (a) 0.05 g of at least one of titanium and titanium diboride and (b) 0.05 g tin, the adhesive layer has a thickness of 0.02-0.06 mm, and the total thickness of the initial wetting auxiliary material is 0.1-4 mm.

67. The initial wetting auxiliary material according to claim 65, wherein tin powder is added to at least one of the wetting agent and the adhesive.

68. The initial wetting auxiliary material according to claim 52, wherein the adhesive is an adhesion layer having a thickness of 0.02-0.06 mm.

69. The initial wetting auxiliary material according to claim 49, wherein the foil material is provided with one of an embossment and an imprint.

70. An electrically heatable ceramic vaporiser body, comprising:
a vaporiser surface being used for an operation in a PVD metallisation installation for vaporising aluminium, and
nitrogen as a material component,
wherein the vaporiser body has an initial wetting auxiliary material applied to the vaporiser surface, the auxiliary material comprising a powder mixture that comprises (a) aluminium in powder form having a particle size which is at most 0.6 mm, the aluminium in powder form melting on the vaporiser surface after initiating the operation of the vaporiser body and reacting with the nitrogen of the vaporiser body to form an aluminium nitride layer on the vaporiser surface and (b) a wetting agent in powder form promoting an even and large-surface distribution of the molten aluminium on the vaporiser surface.

71. The vaporiser body according to claim 70, wherein the vaporiser body is a mixed ceramic having major components that are titanium diboride and boron nitride, a mixing ratio being between 40 weight % and 60 weight %.

72. An electrically heatable ceramic vaporiser body, comprising:
a vaporiser surface being used for an operation in a PVD metallisation installation for vaporising aluminium, and
nitrogen as a material component,
wherein the vaporiser body has an initial wetting auxiliary material applied to the vaporiser surface, the auxiliary material comprising (a) a material being one of a foil material and a sheet material, the material comprising one of aluminium and an aluminium alloy, the material melting after initialing the operation of the vaporiser body and reacting with the nitrogen of the vaporiser body to form an aluminium nitride layer on the vaporiser surface, and (b) a wetting agent one of (1) alloyed to, (2) applied to and (3) alloyed to and applied to the material promoting an even and large-surface distribution of the molten aluminium on the vaporiser surface.

73. The vaporiser body according to claim 72, wherein the vaporiser body is a mixed ceramic having major components that are titanium diboride and boron nitride, a mixing ratio being between 40 weight % and 60 weight %.

74. A method, comprising:
providing a vaporiser surface of an electrically heatable ceramic vaporiser body, the vaporiser body being used for operation in a PVD metallisation installation for vaporising aluminium, the vaporiser body containing nitrogen as a material component; and
applying an initial wetting auxiliary material, the initial wetting auxiliary material comprising a powder mixture that comprises (a) aluminium in powder form having a particle size which is at most 0.6 mm, the aluminium in powder form melting on the vaporiser surface after initiating the operation of the vaporiser body and reacting with the nitrogen of the vaporiser body to form an aluminium nitride layer on the vaporiser surface and (b) a wetting agent in powder form promoting an even and large-surface distribution of the molten aluminium on the vaporiser surface.

75. A method, comprising:
providing a vaporiser surface of an electrically heatable ceramic vaporiser body, the vaporiser body being used for operation in a PVD metallisation installation for vaporising aluminium, the vaporiser body containing nitrogen as a material component; and
applying an initial wetting auxiliary material, the initial wetting auxiliary material comprising (a) a material being one of a foil material and a sheet material, the material comprising one of aluminium and an aluminium alloy, the material melting after initiating the operation of the vaporiser body and reacting with the nitrogen of the vaporiser body to form an aluminium nitride layer on the vaporiser surface, and (b) a wetting agent one of (1) alloyed to, (2) applied to and (3) alloyed to and applied to the material promoting an even and large-surface distribution of the molten aluminium on the vaporiser surface.
